(19) United States
(12) Patent Application Publication
(10) Pub. No.: US 2024/0140220 A1
(43) Pub. Date: May 2, 2024

(54) ELECTRIC VEHICLE SUPPLY EQUIPMENT FOR VEHICLE-TO-VEHICLE BATTERY CHARGING

(71) Applicant: Aptiv Technologies AG, Schaffhausen (CH)

(72) Inventors: Jeffrey KIKO, Kent, OH (US); Don BIZON, Boardman, OH (US); Anthony RASCHILLA, Girard, OH (US); Mark FREDRICKSON, Rootstown, OH (US); Stephen KOULIANOS, Poland, OH (US); Boris BORIN, Willoughby Hills, OH (US)

(21) Appl. No.: 18/383,988

(22) Filed: Oct. 26, 2023

Related U.S. Application Data
(60) Provisional application No. 63/419,395, filed on Oct. 26, 2022.

(51) Int. Cl. B60L 53/16; B60L 53/18

(52) U.S. Cl. CPC B60L 53/16; B60L 53/18

(57) ABSTRACT

An electric vehicle supply equipment may include electrical power transfer circuitry having a power input and a power output. An electric vehicle supply equipment may include a recipient connector connected to the power output and configured to interconnect with a recipient charge port of a recipient vehicle. An electric vehicle supply equipment may include a donor connector connected to the power input and configured to interconnect with a donor charge port of a donor vehicle, wherein the donor connector has one or more electrical attributes that distinguish the donor connector from the recipient connector.

### CROSS-REFERENCE TO RELATED APPLICATION

This application claims benefit of priority to U.S. Provisional Patent Application No. 63/419,395, titled “Electric Vehicle Supply Equipment for Vehicle-To-Vehicle Battery Charging”, filed on Oct. 26, 2022, the contents of which are incorporated by reference herein.

### TECHNICAL FIELD

This patent application is directed to electric vehicle supply equipment configured to support transfer of electrical power from the power grid to a recipient electrical vehicle and to support transfer electrical power from a donor electrical vehicle to a recipient electrical vehicle or other devices requiring electrical power.

### BACKGROUND

Electric vehicle supply equipment (EVSE) typically have a power input connected to an electrical grid based power source, e.g., connected to a 120V AC source by an electrical cable having a NEMA 5-15 connector or connected to a 240V AC source by an electrical cable having a NEMA 14-50 connector. The EVSE also has a power output that is connected to a charge inlet of an electrical vehicle, e.g., by an electrical cable terminated by a charging connector conforming to a charging standard, such as Society of Automotive Engineers (SAE) standard J1772_201710 (SAE J1772), and commonly known as the Combined Charging Standard (CCS1), TESLA's North American Charging Standard (NACS), the International Electrotechnical Commission (IEC) Standard 62196 (also known as CCS2), the Japan Automobile Research Institute CHAdeMO standard, or the Goubiao/T (GBT) 20234.1 standard.

### SUMMARY

In some aspects, the techniques described herein relate to an electric vehicle supply equipment (EVSE) configured to provide electrical power from a donor vehicle to a recipient vehicle, the EVSE including: electrical power transfer circuitry having a power input and a power output; a recipient connector connected to the power output and configured to interconnect with a recipient charge port of the recipient vehicle; and a donor connector, connected to the power input and configured to interconnect with a donor charge port of the donor vehicle, wherein the donor connector has one or more electrical attributes that distinguish the donor connector from the recipient connector.

In some aspects, the techniques described herein relate to a method of charging a battery of a recipient electrical vehicle using electrical power from a battery of a donor electrical vehicle, including: connecting a donor connector of an electric vehicle supply equipment to a donor charge port of a donor vehicle, wherein the donor connector is connected to a power input of the electric vehicle supply equipment; connecting a recipient connector of the electric vehicle supply equipment to a recipient charge port of a recipient vehicle, wherein the recipient connector is connected to a power output of the electric vehicle supply equipment, wherein the donor connector has one or more electrical attributes that distinguish the donor connector from the recipient connector; detecting an electrical attribute of the donor connector via an on-board control module in the donor vehicle; and providing electrical power from a donor battery in the donor vehicle to a recipient battery in the recipient vehicle via the electric vehicle supply equipment.

In some aspects, the techniques described herein relate to an electric vehicle, including: a battery; a charge port conforming to a charging standard and configured to receive a charging connector; and an on-board control module containing software that, when executed, causes the on-board control module to: transfer electrical power from the charge port to the battery when the on-board control module detects that one or more electrical attributes of the charging connector are within a specified range of values according to the charging standard, and transfer electrical power from the battery to the charge port when the on-board control module detects that one or more electrical attributes are outside the specified range of values according to the charging standard.

### BRIEF DESCRIPTION OF THE DRAWINGS

The present invention will now be described, by way of example with reference to the accompanying drawings, in which:

FIG. 1 shows a schematic view of an EVSE connected between a donor vehicle and a recipient vehicle according to some embodiments.

FIG. 2 shows an isometric view of an EVSE having a detachable donor vehicle connector and a fixed recipient vehicle connector according to some embodiments.

FIG. 3 shows a schematic electrical diagram of proximity circuitry in the donor vehicle connector and the recipient vehicle connector according to some embodiments.

FIG. 4 shows a flow chart of a method of transferring electrical power from a battery of a donor electrical vehicle to a battery of a recipient electrical vehicle according to some embodiments.

### DETAILED DESCRIPTION

When an electrical vehicle is in an extremely low state of charge (SoC) and does not have access to grid powered electric vehicle supply equipment (EVSE), it may be desirable to provide a charge to the battery of this low SoC vehicle, hereafter referred to as the recipient vehicle, from a portable electrical power source, for example another electrical vehicle having a higher SoC, hereafter referred to as the donor vehicle. For example, this power transfer from the donor vehicle may be used to provide a sufficient charge to the recipient vehicle to allow the recipient vehicle to drive to a grid powered charging station.

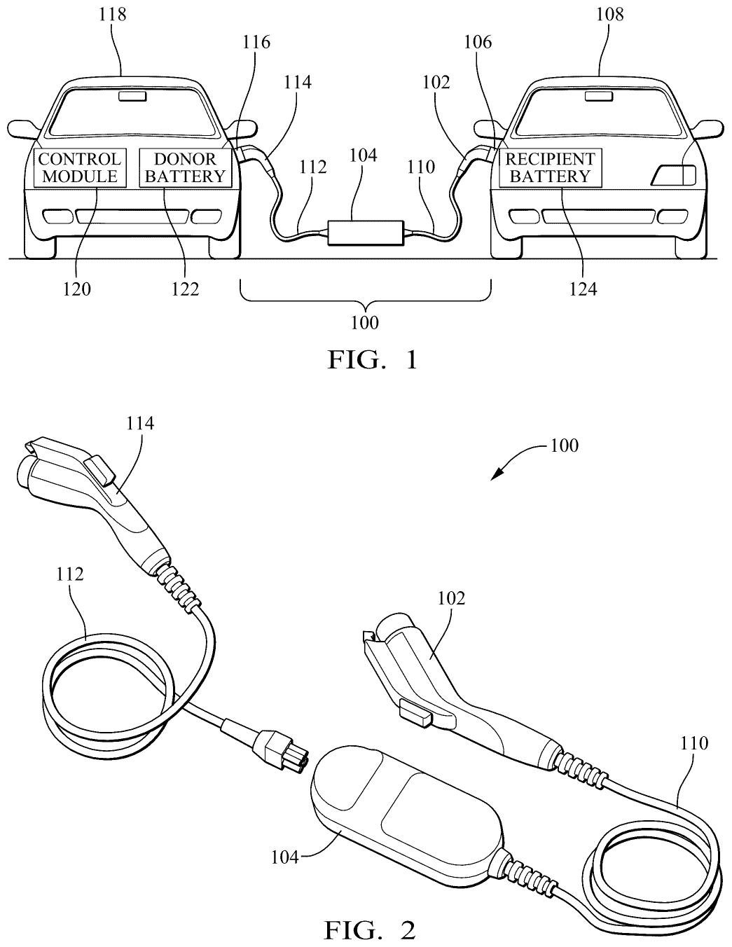

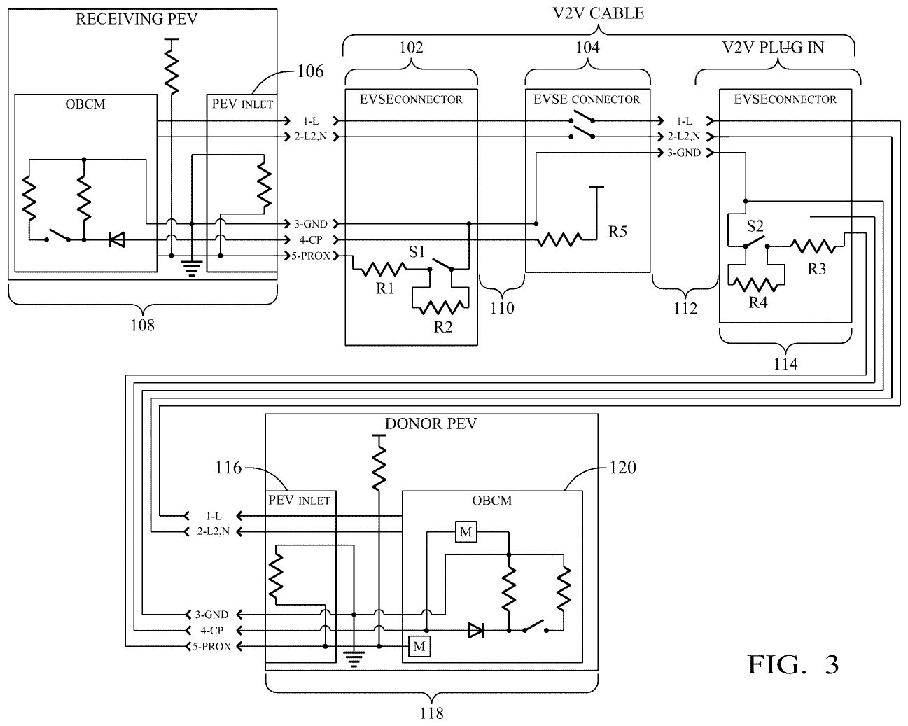

Electric vehicle supply equipment, hereafter referred to as EVSE 100, that is configured for transferring electrical power from a donor vehicle to a recipient vehicle is presented herein. As shown in the non-limiting example of FIGS. 1 and 2, EVSE 100 has one CCS1 standard (SAE J1772) connector, hereafter referred to as recipient connector 102, that is used to connect electrical power transfer circuitry 104 to a recipient charge port 106 in a recipient vehicle 108 via electrical cable 110. In this example, the EVSE 100 also has a detachable power cable 112 that is terminated by a donor connector 114 that is configured to connect with a donor charge port 116 in the donor vehicle 118. In some embodiments, the donor connector 114 has a physical interface to the donor charge port 116 that is identical to the physical interface of the CCS1 type connector. However, in some embodiments the electrical circuitry within the donor connector 114 is different from the recipient connector 102. As described in more detail below, the differences in electrical circuitry associated with the donor connector 114 (as compared with the recipient connector 102) allows an on-board control module 120 located on the donor vehicle 118 to detect the connection of the donor connector 114 and determine that the donor vehicle 118 should operate in a charging mode to provide power from the donor vehicle 118 to the recipient vehicle 108 without requiring communication from the EVSE 100. In some embodiments, the donor connector 114 does not fully conform to the CCS1 standard as a result of these differences in the electrical circuitry.

In some embodiments, the detachable power cable 112 that is terminated by the donor connector 114 may be disconnected from the EVSE 100 and replaced by a grid power cord (not shown) that allows the EVSE 100 to be powered by the electrical grid rather than the donor vehicle 118.

In some embodiments, differences in electrical attributes between the recipient connector 102 and the donor connector 114 are a proximity signal provided by the respective connectors to the donor charge port 116. For example, the donor connector 114 may provide a proximity signal (referred to herein as a first proximity signal) that is different or distinguishable from the proximity signal (referred to herein as the second proximity signal) generated by the recipient connector 102. In some embodiments, the recipient connector 102 provides a proximity signal that is defined by the CCS1 standard communication protocol.

In some embodiments, differences in electrical attributes between the recipient connector 102 and the donor connector 114 are provided by the presence or absence of a control pilot signal. For example, in some embodiments, the recipient connector 102 provides a control pilot signal line CP (shown in FIG. 3) when connected to the recipient vehicle 108 according to a CCS1 standard. In some embodiments, the donor connector 114 differs from the CCS1 standard because the donor connector 114 is not configured to and does not provide a control pilot signal line when connected to the donor vehicle 118.

In some embodiments, a control module 120 in the donor vehicle 118 may be programmed to detect one or more electrical attributes (e.g., a proximity signal and/or lack of control pilot signal) to determine that the donor vehicle 118 needs to provide electrical power to, rather than receive power from, the donor charge port 116 and thereby the electrical power transfer circuitry 104 via the donor connector 114 and detachable power cable 112. For example, in some embodiments, the control module 120 detects the proximity signal provided by the donor connector 114 and utilizes the detected proximity signal (either first proximity signal or second proximity signal) to detect the type of connector connected to the donor charge port 116. If the control module 120 detects the second proximity signal the control module 120 determines that a recipient connector 102 is connected to the donor charge port 116, indicating that the donor charge port 116 will be utilized to receive charging power. Conversely, if the control module 120 detects the first proximity signal the control module 120 determines that a donor connector 114 is connected to the donor charge port 116, indicating that the donor charge port 116 will be utilized to provide charging power to a recipient vehicle 108. Likewise, the presence or absence of a control pilot signal may also be utilized by the control module 120 to determine whether the recipient connector 102 or donor connector 114 is connected to the donor charge port 116. In some embodiments, the control module 120 utilizes a combination of two or more electrical attributes to determine whether the recipient connector 102 or donor connector 114 is connected to the donor charge port 116.

While the recipient connector 102 and the donor connector 114 contained in this example conform with or are based on the SAE J1772 standard, in other embodiments, the recipient and donor connectors may be modified to conform with or be based on other electric vehicle charging connector standards, such as the NACS, CCS2, CHAdeMO, or GBT standards. Alternatively, the donor connector may be based on one of these standards while the recipient connector may be based on a different standard. In each case, electrical attributes of the donor connector 114 are modified as compared with the recipient connector 102 to allow the control module 120 to distinguish between the respective connectors.

The EVSE 100 may be configured so that the detachable power cable 112 terminated by donor connector 114 may be replaced by a power cable having a power grid connector such as a NEMA 5-15 or 14-50 connector (not shown). This allows the EVSE 100 to be used for both grid based charging and vehicle-to-vehicle charging.

The circuitry hardware differences in the donor connector 114 (i.e., proximity signal and/or lack of control pilot signal) allow a control module 120 in the donor vehicle 118 to be programmed to detect that the control module 120 should switch to a vehicle-to-vehicle charging mode without the need for any communication from the EVSE 100 or the recipient vehicle 108. This allows the EVSE 100 to support vehicle-to-vehicle charging without any changes required to the EVSE 100. During normal charging operation, software in the control module 120 of the donor vehicle 118 causes electrical power to be transferred via the electrical power transfer circuitry 104 to the donor charge port 116, which is then supplied to the donor battery 122 (i.e., typical charging operation of the donor vehicle 118 when the control module 120 detects that a value of a proximity circuit in the charging connector is within a specified range of values of the proximity circuit and/or detects a control pilot signal according to the charging standard). The software in the control module 120 in the donor vehicle 118 is also programmed to cause electrical power from the donor battery 122 to be supplied via the donor charge port 116 and the electrical power transfer circuitry 104 to the recipient charge port 106 and then to the recipient battery 124 when the control module 120 detects a proximity signal and/or lack of control pilot signal from a charging connector connected to the donor charge port 116.

Other embodiments may be envisioned that allow the EVSE 100 to provide electrical power from the donor vehicle 118 to other devices requiring electrical power, such as back-up emergency power for a home or other building (not shown).

FIG. 3 is a circuit diagram that illustrates differences in electrical attributes associated with the recipient connector 102 and the donor connector 114 according to some embodiments. As described with respect to FIG. 1 above, the EVSE 100 is connected between recipient vehicle 108 and donor vehicle 118. The EVSE 100 includes a recipient connector 102 having physical connections configured to interface with recipient charge port 106 and a donor connector 114 having physical connections configured to interface with donor charge port 116. As described above, the recipient connector 102 and the donor connector 114 may have physical attributes that conform with or are based on a particular standard (e.g., SAE J1772, NACS, CCS2, CHAdeMO, GB T, etc.). For example, this may include number, geometry, and positioning of output terminals configured to interface with the recipient charge port 106 and the donor charge port 116. In this particular example, recipient connector 102 includes first and second power ports L1, L2, a ground port, a control pilot port CP, and a proximity port PROX. Likewise, the donor connector 114 includes first and second power ports L1, L2, a ground port, a control pilot port CP, and a proximity port PROX.

The donor connector 114 is defined by one or more electrical attributes that make it distinguishable from the recipient connector 102. For example, recipient connector 102 may include a pair of proximity resistors R1, R2, wherein resistor R2 is selectively connected in series with resistor R1 based on the state (e.g., open/closed) of proximity switch S1. In one embodiment, switch S1 remains open if recipient connector 102 is not engaged with the recipient charge port 106 and is closed if recipient connector 102 is engaged/mated with the recipient charge port 106. The voltage provided at the proximity port PROX1 is a function of the resistors R1, R2 and the state of the switch S1. The donor connector 114 similarly includes proximity resistors R3, R4, wherein resistor R4 is selectively connected in series with resistor R3 based on the state (open/closed) of proximity switch S2. The voltage provided at the proximity port PROX2 of the donor connector 114 is a function of the resistors R3, R4 and the state of the switch S2. By selecting the values of one or both of resistors R3, R4 to be different than the value of resistors R1, R2, the voltage provided at proximity port PROX2 is distinguishable from the voltage provided at proximity port PROX1. In some embodiments, the voltage provided at proximity port PROX2 must be distinguishable from the voltage provided at proximity port PROX1 regardless of the state of proximity switches S1 and S2. For example, in some embodiments the range of voltages provided at proximity port PROX2 (based on whether proximity switch S2 is opened/closed) does not overlap with the range of voltages provided at proximity port PROX1 (regardless of whether proximity switch S1 is opened/closed).

In some embodiments, the recipient connector 102 includes a control pilot signal line CP that is connected to the power transfer circuitry 104. In this embodiment, the control pilot signal line CP is connected to a voltage source via resistor R5. In some embodiments, the control pilot signal is a pulse-width modulated signal utilized by the recipient vehicle 108 as a control signal. In some embodiments, the donor connector 114 has a control pilot signal line, but the signal is not connected to the power transfer circuitry 104. As a result, no control signal (e.g., pulse-width modulated control signal) is provided to the donor charge port 116 via the control pilot signal line CP. In some embodiments, the control module 120 utilizes the lack of control pilot signal to distinguish between a recipient connector 102 and a donor connector 114.

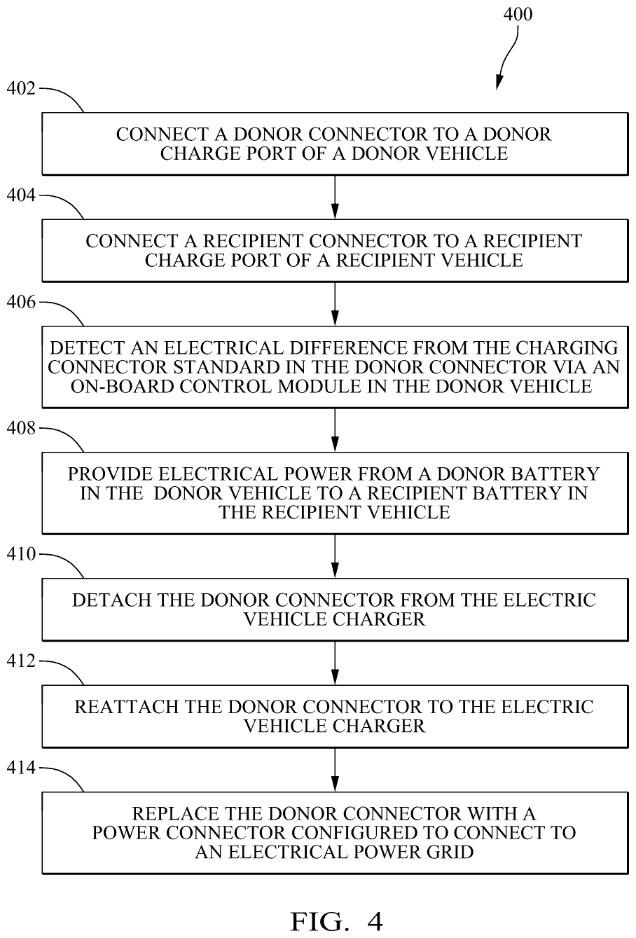

In this way, the electrical attributes of the donor connector 114 are distinguishable from the electrical attributes of the recipient connector 102, allowing the control module 120 on the donor vehicle to detect the presence (or absence) of the donor connector 114. As such, when the control module 120 detects the presence of electrical attributes indicative of a standard connector such as recipient connector 102 (i.e., in a typical charging operation) the software in the control module 120 in the donor vehicle 118 is programmed to command the electrical power transfer circuitry 104 to transfer electrical power to the donor charge port 116, which is then supplied to the donor battery 122 of the donor vehicle 118. Likewise, software in the control module 120 in the donor vehicle 118 is also programmed to command the electrical power transfer circuitry 104 to transfer electrical power from the donor charge port 116 to the recipient charge port 106 of the recipient vehicle 108 when the control module 120 detects the presence of electrical attributes indicative of a donor connector 114 (i.e., a donor vehicle charging operation). FIG. 4 is a flowchart illustrating a method 400 of charging the recipient battery 124 of the recipient vehicle 108 using electrical power from the donor battery 122 of the donor electrical vehicle 118.

At STEP 402, a donor connector of an electric vehicle supply equipment is connected to a charge port of a donor vehicle. In some embodiments, this may include connecting a donor connector 114 of an EVSE 100 to a donor charge port 116 of a donor vehicle 118. The donor connector 114 is connected to a power input of the EVSE 100.

At STEP 404, a recipient connector of the electric vehicle supply equipment is connected to a charge port of a recipient vehicle. In some embodiments, this includes connecting a recipient connector 102 of the EVSE 100 to a recipient charge port 106 of a recipient vehicle 108. The recipient connector 102 is connected to a power output of the EVSE 100. In some embodiments, the recipient connector 102 conforms with a charging connector standard such as CCS1, NACS, CCS2, CHAdeMO, or GBT. As discussed above, the donor connector 114 physically conforms with the charging connector standard but does not electrically conform with the charging connector standard;

At STEP 406, an electrical difference from the charging connector standard in the donor connector is detected by an on-board control module in the donor vehicle. In some embodiments, this includes detecting an electrical difference from the charging connector standard in the donor connector 114 via a control module 120 in the donor vehicle 118. The control module 120 may detect that a resistance value of a proximity circuit of the donor connector is different than the charging connector standard, e.g., 150 or 480 ohms. The on-board control module may detect that a resistance value of a proximity circuit of the donor connector is 261 or 471 ohms. The on-board control module may detect that the donor connector does not provide a control pilot signal.

At STEP 408, electrical power from a donor battery in the donor vehicle is provided to a recipient battery in the recipient vehicle via the electric vehicle supply equipment. In some embodiments, this includes providing electrical power from a donor battery in the donor vehicle 118 to a recipient battery in the recipient vehicle 108 via the electrical power transfer circuitry 104 in the EVSE 100;

At STEP 410, the donor connector may be detached from the electric vehicle supply equipment. For example, the donor connector 114 may be detached from the EVSE 100.

At STEP 412, the donor connector may be reattached to the electric vehicle supply equipment. For example, the donor connector 114 may be reattached to the EVSE 100.

At STEP 414, the donor connector may be replaced with a power connector configured to connect to an electrical power grid. For example, the donor connector 114 may be replaced with a power connector configured to connect to an electrical power grid.

### Discussion of Possible Embodiments

The following are non-exclusive descriptions of possible embodiments of the present invention.

In some aspects, the techniques described herein relate to an electric vehicle supply equipment (EVSE) configured to provide electrical power from a donor vehicle to a recipient vehicle, the EVSE including: electrical power transfer circuitry having a power input and a power output; a recipient connector connected to the power output and configured to interconnect with a recipient charge port of the recipient vehicle; and a donor connector, connected to the power input and configured to interconnect with a donor charge port of the donor vehicle, wherein the donor connector has one or more electrical attributes that distinguish the donor connector from the recipient connector.

The electric vehicle supply equipment of the preceding paragraph can optionally include, additionally and/or alternatively any, one or more of the following features, configurations and/or additional components.

The donor connector provides a first proximity signal that is always different than a second proximity signal provided by the recipient connector when the electrical power transfer circuitry is operating.

A second proximity signal provided by the recipient connector according to a charging standard operates within a specified range of values and wherein a first proximity signal provided by the donor connector operates outside the specified range of values utilized by the recipient connector.

The donor connector includes a first proximity circuit having a resistance value of 261 or 471 ohms.

The recipient connector includes a second proximity circuit having a resistance value of 150 or 480 ohms.

A resistance value of a proximity circuit of the donor connector has a value other than 150 or 480 ohms.

The recipient connector provides a control pilot signal and wherein the donor connector does not provide a control pilot signal.

The donor connector is detachable from and reconnectable to the electric vehicle supply equipment.

The donor connector is replaceable with a power connector configured to connect to an electrical power grid.

In some aspects, the techniques described herein relate to a method of charging a battery of a recipient electrical vehicle using electrical power from a battery of a donor electrical vehicle, including: connecting a donor connector of an electric vehicle supply equipment to a donor charge port of a donor vehicle, wherein the donor connector is connected to a power input of the electric vehicle supply equipment; connecting a recipient connector of the electric vehicle supply equipment to a recipient charge port of a recipient vehicle, wherein the recipient connector is connected to a power output of the electric vehicle supply equipment, wherein the donor connector has one or more electrical attributes that distinguish the donor connector from the recipient connector; detecting an electrical attribute of the donor connector via an on-board control module in the donor vehicle; and providing electrical power from a donor battery in the donor vehicle to a recipient battery in the recipient vehicle via the electric vehicle supply equipment.

The method of the preceding paragraph can optionally include, additionally and/or alternatively any, one or more of the following features, configurations and/or additional components.

The on-board control module detects that a resistance value of a proximity circuit of the donor connector is different than 150 or 480 ohms.

The on-board control module detects that a resistance value of a proximity circuit of the donor connector is 261 or 471 ohms.

The on-board control module detects that the donor connector does not provide a control pilot signal.

The method further includes detaching the donor connector from the electric vehicle supply equipment.

The method further includes reattaching the donor connector to the electric vehicle supply equipment.

The method further includes replacing the donor connector with a power connector configured to connect to an electrical power grid.

In some aspects, the techniques described herein relate to an electric vehicle, including: a battery; a charge port conforming to a charging standard and configured to receive a charging connector; and an on-board control module containing software that, when executed, causes the on-board control module to: transfer electrical power from the charge port to the battery when the on-board control module detects that one or more electrical attributes of the charging connector are within a specified range of values according to the charging standard, and transfer electrical power from the battery to the charge port when the on-board control module detects that one or more electrical attributes are outside the specified range of values according to the charging standard.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electric vehicle supply equipment (EVSE) configured to provide electrical power from a donor vehicle to a recipient vehicle, the EVSE comprising:
electrical power transfer circuitry having a power input and a power output;
a recipient connector connected to the power output and configured to interconnect with a recipient charge port of the recipient vehicle; and
a donor connector, connected to the power input and configured to interconnect with a donor charge port of the donor vehicle, wherein the donor connector has one or more electrical attributes that distinguish the donor connector from the recipient connector.

2. The electric vehicle supply equipment according to claim 1, wherein the donor connector provides a first proximity signal that is always different than a second proximity signal provided by the recipient connector when the electrical power transfer circuitry is operating.

3. The electric vehicle supply equipment according to claim 1, wherein a second proximity signal provided by the recipient connector according to a charging standard operates within a specified range of values and wherein a first proximity signal provided by the donor connector operates outside the specified range of values utilized by the recipient connector.

4. The electric vehicle supply equipment according to claim 1, wherein the donor connector includes a first proximity circuit having a resistance value of 261 or 471 ohms.

5. The electric vehicle supply equipment according to claim 1, wherein the recipient connector includes a second proximity circuit having a resistance value of 150 or 480 ohms.

6. The electric vehicle supply equipment according to claim 5, wherein a resistance value of a proximity circuit of the donor connector has a value other than 150 or 480 ohms.

7. The electric vehicle supply equipment according to claim 1, wherein the recipient connector provides a control pilot signal and wherein the donor connector does not provide a control pilot signal.

8. The electric vehicle supply equipment according to claim 1, wherein the donor connector is detachable from and reconnectable to the electric vehicle supply equipment.

9. The electric vehicle supply equipment according to claim 8, wherein the donor connector is replaceable with a power connector configured to connect to an electrical power grid.

10. A method of charging a battery of a recipient electrical vehicle using electrical power from a battery of a donor electrical vehicle, comprising:
connecting a donor connector of an electric vehicle supply equipment to a donor charge port of a donor vehicle, wherein the donor connector is connected to a power input of the electric vehicle supply equipment;
connecting a recipient connector of the electric vehicle supply equipment to a recipient charge port of a recipient vehicle, wherein the recipient connector is connected to a power output of the electric vehicle supply equipment, wherein the donor connector has one or more electrical attributes that distinguish the donor connector from the recipient connector;
detecting an electrical attribute of the donor connector via an on-board control module in the donor vehicle; and
providing electrical power from a donor battery in the donor vehicle to a recipient battery in the recipient vehicle via the electric vehicle supply equipment.

11. The method according to claim 10, wherein the electrical attribute is a resistance value of a proximity circuit, and wherein the on-board control module detects that the resistance value is different than 150 or 480 ohms.

12. The method according to claim 10, wherein the electrical attribute is a resistance value of a proximity circuit, and wherein the on-board control module detects that the resistance value is 261 or 471 ohms.

13. The method according to claim 10, wherein the on-board control module detects that the donor connector does not provide a control pilot signal.

14. The method according to claim 10, further comprising detaching the donor connector from the electric vehicle supply equipment.

15. The method according to claim 14, further comprising reattaching the donor connector to the electric vehicle supply equipment.

16. The method according to claim 14, further comprising replacing the donor connector with a power connector configured to connect to an electrical power grid.

17. An electric vehicle, comprising:
a battery;
a charge port conforming to a charging standard and configured to receive a charging connector; and
an on-board control module containing software that, when executed, causes the on-board control module to:
transfer electrical power from the charge port to the battery when the on-board control module detects that one or more electrical attributes of the charging connector are within a specified range of values according to the charging standard, and
transfer electrical power from the battery to the charge port when the on-board control module detects that one or more electrical attributes are outside the specified range of values according to the charging standard.
